(19) United States
(12) Patent Application Publication
(10) Pub. No.: US 2009/0324024 A1
(43) Pub. Date: Dec. 31, 2009

(54) SYSTEM AND METHOD FOR IMPROVING POSTURE

(75) Inventor: Philip Worthington, Macclesfield (GB)

Correspondence Address: DAVID A. GUERRA;INTERNATIONAL PATENT GROUP, LLC, 2025 17TH AVENUE N.W., CALGARY, AB, T2M 0S7, CA

(73) Assignee: POSTUREMINDER LTD, Ashton-under-Lyne (GB)

(21) Appl. No.: 12/197,112

(22) Filed: Aug. 22, 2008

(30) Foreign Application Priority Data
Jun. 25, 2008 (GB) 0811644.4
Aug. 14, 2008 (GB) 0814794.4

(51) Int. Cl. G06K 9/00

(52) U.S. Cl. 382/118

(57) ABSTRACT

A system and method are provided for monitoring the posture of a user of the system, for example a user sitting at a computing device. A camera device is used for periodically capturing an image of a user; and for each captured image: a previously determined face detection model is applied to the image to detect a face of a user in the image; the detected face is compared to a previously determined good posture face to detect an instance of good posture; and a good posture message is generated to a user after a number of instances of good posture are detected.

### CROSS-REFERENCE TO RELATED APPLICATION

This application is a Paris Convention entry application based upon co-pending Great Britain application 0814794.4 filed on Aug. 14, 2008 and Great Britain application 0811644.4 filed on Jun. 25, 2008. Additionally, this U.S. application claims the benefit of priority of co-pending Great Britain application 0814794.4 filed on Aug. 14, 2008 and Great Britain application 0811644.4 filed on Jun. 25, 2008. The entire disclosures of the prior applications are incorporated herein by reference.

### BACKGROUND OF THE INVENTION

1. Field of the Invention

The present invention relates to a system and method for improving posture, in particular for improving the posture of a user of a computing device.

2. Description of the Prior Art

The use of posture feedback systems is known in the prior art. People can experience muscle fatigue and experience musculoskeletal damage when sitting for long periods of time in a poor posture. The most common example is probably users of computer systems sitting for long periods of time while working at a computing device.

A system is described in published U.S. application 2006/0045312 for providing real time feedback to users of a computing device when they move into a poor posture. The primary application of this system is to monitoring the swings of a golfer during their training sessions. Real-time feedback to a computer user when they shift out of a good posture during periods in which they are working at a computing device can be annoying and distracting to the user. In addition, this system uses complex methodology involving associative models for determining a good posture image and for comparing a good posture image to a model based on multiple test images.

A further system is described in U.S. Pat. No. 7,315,249, which is complicated by the requirement of the system to determine the user's physical environment and the use of a biomechanical model of whole-body good posture. This system also aims to provide the computer user with real time feedback, which as indicated above can be annoying and distracting to the computer user while they are working.

While the above-described devices fulfill their respective, particular objectives and requirements, the aforementioned patents do not describe a system and method for improving posture that allows for improving the posture of a user of a computing device.

Therefore, a need exists for a new and improved system and method for improving posture that can be used for improving the posture of a user of a computing device. In this regard, the present invention substantially fulfills this need. In this respect, the system and method for improving posture according to the present invention substantially departs from the conventional concepts and designs of the prior art, and in doing so provides an apparatus primarily developed for the purpose of for improving the posture of a user of a computing device.

### SUMMARY OF THE INVENTION

In view of the foregoing disadvantages inherent in the known types of posture feedback systems now present in the prior art, the present invention provides an improved system and method for improving posture, and overcomes the above-mentioned disadvantages and drawbacks of the prior art. As such, the general purpose of the present invention, which will be described subsequently in greater detail, is to provide a new and improved system and method for improving posture and method which has all the advantages of the prior art mentioned heretofore and many novel features that result in a system and method for improving posture which is not anticipated, rendered obvious, suggested, or even implied by the prior art, either alone or in any combination thereof.

According to a first aspect of the present invention, there is provided a system for monitoring the posture of a user of the system, comprising: a camera device for periodically capturing an image of a user; and for each captured image: means for applying a previously determined face detection model to the image to detect a face of a user in the image; means for comparing the detected face to a previously determined good posture face to detect an instance of good posture; and means for generating a good posture message to a user after a number of instances of good posture are detected. This acts as a positive incentive to a user to sit in a good posture and provides positive feedback when they achieve a good posture over a period of time. It has also been found that some users of the system may remain rigidly in a good posture, which is also not beneficial. Accordingly, the present invention provides a message where an extended period of good posture is detected to warn users against sitting rigidly.

The number of instances may correspond to good posture messages appearing after a predetermined period of time in which the user is sitting in a consistently good posture, i.e. no incidences of poor posture are detected during the predetermined time period. The predetermined time period may be set by the user.

The system according to the present invention may detect the user's face in a captured image in order to estimate their current posture. This facilitates a less complex system for determining posture, without excessive use of computational or memory resources. In addition, the system according to the present invention may provide feedback to the user only after a number (greater than 1) of good posture instances are detected and so does not overly intrude on the user's working time at the computing device. In this way, the present system may be in operation all the time that the user is using the computing device.

The system may be integrated into or connected to a computing device and the user may be a user of the computing device. In this case, the camera may be connected to the computing device.

The system may additionally comprising means for comparing the detected face to a previously determined good posture face to detect an instance of poor posture; and means for generating a poor posture reminder to a user after a number of instances of poor posture are detected. The number of instances may correspond to reminders appearing between 30 seconds and 10 minutes of consistent poor posture and may, for example, depend on user preference and the degree of poor posture.

The system may comprise means for calculating a good posture rating related to the number of incidences of good posture detected and the number of incidences of poor posture detected, for example, over a period of time. The rating or score may be presented to the user, for example, during or at the end of a session of the user using the system, for example at the end of a user's session working at a computing device, in particular at the end of the working day. The generation of such a score may encourage the user to sit in a good posture and adds an element of competition. The system may comprise comparison means for comparing good posture ratings from a plurality of users of the system and for example may also comprise ranking means for ranking the users based on the resulting comparison. Thus, where several users are using the system, for example on computing devices in an office environment, in particular where the user's computing devices are networked together to a central server or have internet access, the system may rank the good posture ratings or scores of the users and may provide the users with an indication of the relative scores of the users. This introduces an element of competition between users in the office which can encourage users to sit in a good posture.

The means for comparing may compare the position of the detected face within the image to the position of the previously captured good posture face to detect an instance of good or poor posture and/or it may compares the size of the detected face with the size of the previously captured good posture face to detect an instance of good or poor posture. The number of instances of poor posture may vary depending on the degree of poor posture of the user detected. For example, where a user exhibits a minor deviation from good posture, the number of instances may be higher than when the user exhibits a major deviation in posture before the system reminds the user.

When a user has been sitting in a good posture and then moves for a short while into a poor posture, there is no immediate need to disturb the user with a reminder, as it is valuable for the user to shift their position periodically while working at a computing device. Accordingly, the system may additionally comprise means for delaying the good posture message on detecting an instance of poor posture. This also takes into account natural movements of the user at the computing device, for example leaning forwards for short periods to peer at something closely, or if the user moves to look at paperwork at one side of the computing device.

The user's environment may change over time and in particular lighting conditions may vary in the course of the day. In order to account for these variations the system may additionally comprise calibration means for periodically updating the previously determined good posture face and the previously determined skin color model.

In particular, the camera may capture a calibration reference image of a user prompted to move into a good posture and the calibration means may comprise means for displaying the calibration reference image on a screen of the system and means for enabling a user to position a good posture face template over the calibration reference image so as to determine a user positioned face. Asking the user to identify the position of their face in the image improves the accuracy with which the user's face can be located within the image compared to fully automated face detection techniques.

However, to improve the stability of the system, the calibration means may additionally comprise means for updating the previously determined face detection model based on the good posture template as positioned by the user, means for applying the updated face detection model to the calibration reference image and for assigning a reference template over an area of the image corresponding to the face and for using the reference template so as to determine an updated previously determined good posture face. This updates the face location and size so as to improve the stability of the size and location estimates.

The calibration means may be implemented on at least one of the following occasions: on first use of the system; each time the system is switched on, which may be useful where the user of the system or the physical configuration, for example the location, of the system device varies; or after an autorecalibration means of the system detects a predetermined number of instances of a face in an autorecalibration reference image not corresponding to the user positioned face, as is described below.

A user of a computing device would generally prefer not to have to take part in the calibration described above, other than where necessary, in order that their work is not unduly interrupted. To accommodate this, the system according to the present invention may additionally comprise an autorecalibration means. In this case the camera may capture an autorecalibration reference image when a user has been prompted to move into a good posture, and the system may additionally comprise an autorecalibration means which may comprise means for comparing the user positioned face as determined by the user positioned face template to the autorecalibration reference image, means for determining whether a face in the autorecalibration reference image corresponds to the user positioned face; and after a predetermined number of instances of the face in the autorecalibration reference image not corresponding to the user positioned face, the system may use the calibration means for determining an updated previously determined good posture face. Therefore, where the user positioned face significantly varies from the autorecalibration good posture reference image over a number of autorecalibrations, this may be an indication that a further calibration, where a user manually identifies their face in the image, may be necessary. However, where the face in the autorecalibration reference image corresponds to the user positioned face, the autorecalibration means may additionally comprise means for updating the face detection model based on the autorecalibration reference image and means for applying the face detection model to the autorecalibration image and for assigning a reference template over an area of the autorecalibration reference image corresponding to the face and for using the template so as to determine an updated good posture face. The updated face detection model may then become the previously determined face detection model.

As it does not disturb the user, the autorecalibration means may be implemented on at least one of the following occasions: each time the system is switched on, in particular where the system is usually used by the same user in the same physical configuration, for example in the same location; after a posture message or reminder is generated; or when a user is detected returning to the system after a break.

According to a second aspect of the present invention, there is provided a method for monitoring the posture of a user, comprising the steps of: capturing an image of a user; and for each captured image: applying a previously determined face detection model to the image to detect a face of a user in the image; comparing the detected face to a previously determined good posture face to detect an instance of good posture; and generating a good posture message to a user after a number of instances of good posture are detected. The user may be a user of a computing device.

The face detection model may be a statistical face detection model for detecting pixels in the image which have a high probability of being face pixels. For example, the face detection model may be a skin color model. Using a statistical model can reduce the computing power required to monitor the user's posture while providing an accurate estimate of the user's posture. Other non-statistical and/or non-color-based face detection models might replace the statistical model described herein, which will be apparent to the person skilled in the art.

The means for applying the face detection model may comprise means for assigning a template over an area of the image corresponding to the face and for using the template to detect the face. Using a template in this way further simplifies the detection of a users face in a captured image. Good results may be achieved where the template is, for example, an ellipse. The template may be of variable size, which takes account of the size of the user's face and the distance a user typically sits way from a screen of the computing device. In addition, the use of a variable size template facilitates the detection of a user leaning towards the computing device or projecting their neck forwardly, so called vulture necking, in which case the assigned template will become larger.

The system and method according to the present invention may be implemented at least partially by a computer program running on a computing device. Where the user is sitting at a computing device, the system may be implemented at least partially by that computing device. This may include many different types of computing device or signal processor, such as a server or a personal digital assistant (PDA).

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved system and method for improving posture that has all of the advantages of the prior art posture feedback systems and none of the disadvantages.

It is another object of the present invention to provide a new and improved system and method for improving posture that may be easily and efficiently manufactured and marketed.

An even further object of the present invention is to provide a new and improved system and method for improving posture that has a low cost of manufacture with regard to both materials and labor, and which accordingly is then susceptible of low prices of sale to the consuming public, thereby making such system and method for improving posture economically available to the buying public.

Still another object of the present invention is to provide a new system and method for improving posture that provides in the apparatuses and methods of the prior art some of the advantages thereof, while simultaneously overcoming some of the disadvantages normally associated therewith.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the system and method for improving posture illustrating a person sitting at a computing device connected to a webcam and utilizing the system for monitoring posture according to the present invention and constructed in accordance with the principles of the present invention, with phantom lines depicting environmental structure and forming no part of the claimed invention.

FIG. 2 is a flow chart showing the steps of the method for monitoring posture according to the present invention of the system and method for improving posture of the present invention.

FIG. 3 is a flow chart showing the steps of FIG. 2, with steps showing an additional posture rating system of the system and method for improving posture of the present invention.

The same reference numerals refer to the same parts throughout the various figures.

### DESCRIPTION OF THE PREFERRED EMBODIMENT

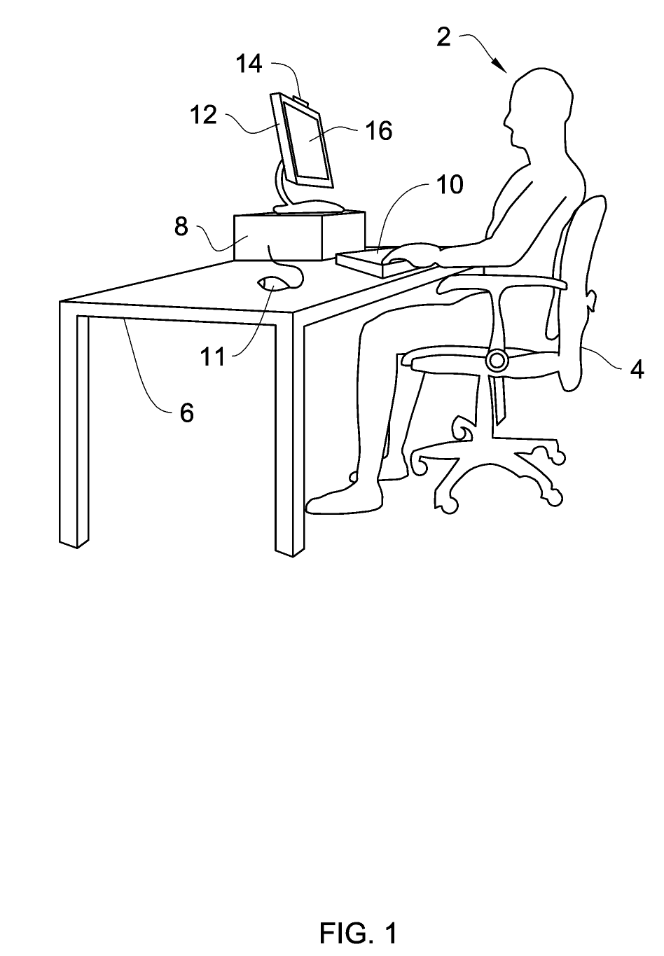

Referring now to the drawings, and particularly to FIGS. 1-3, a preferred embodiment of the system and method for improving posture of the present invention is shown.

FIG. 1 shows a person (2) sitting on a chair (4) at a desk (6) and working at a personal computing device (8) connected to a keyboard (10), a mouse device (11) or other pointing device and a monitor (12) positioned on the desk. The monitor (12) comprises a screen (16) which the person observes while working at the computing device, for example by typing on the keyboard (10). Alternatively, the computing device could be a laptop computing device which is formed integrally with a screen, a keyboard and a mouse or other pointing device. Ideally, the person sits in a good posture, so as to prevent muscle fatigue and progressive damage to the musculoskeletal system, including the spine, shoulders, arms, wrists and hands. A good posture is shown in FIG. 1, with the user sitting in an upright position.

A camera device (14), which may be a digital camera, which will generally be a video camera, webcam or other digital imaging device is connected to or formed integrally with the computing device in a position towards the top of the screen (16) of the computing device. Alternatively, the camera can be located in any position so as to capture a view of the face of the person (2). Many laptop computing devices have such a digital camera, typically a webcam integrated into them typically located above the screen of the laptop. Alternatively, such digital cameras, typically webcams, can be connected to a personal computing device (8) and located on top of the monitor (12) facing towards a user of the monitor or on a separate stand. The digital camera (14) should be located in substantially the same position with respect to the screen during use of the system and method according to the present invention.

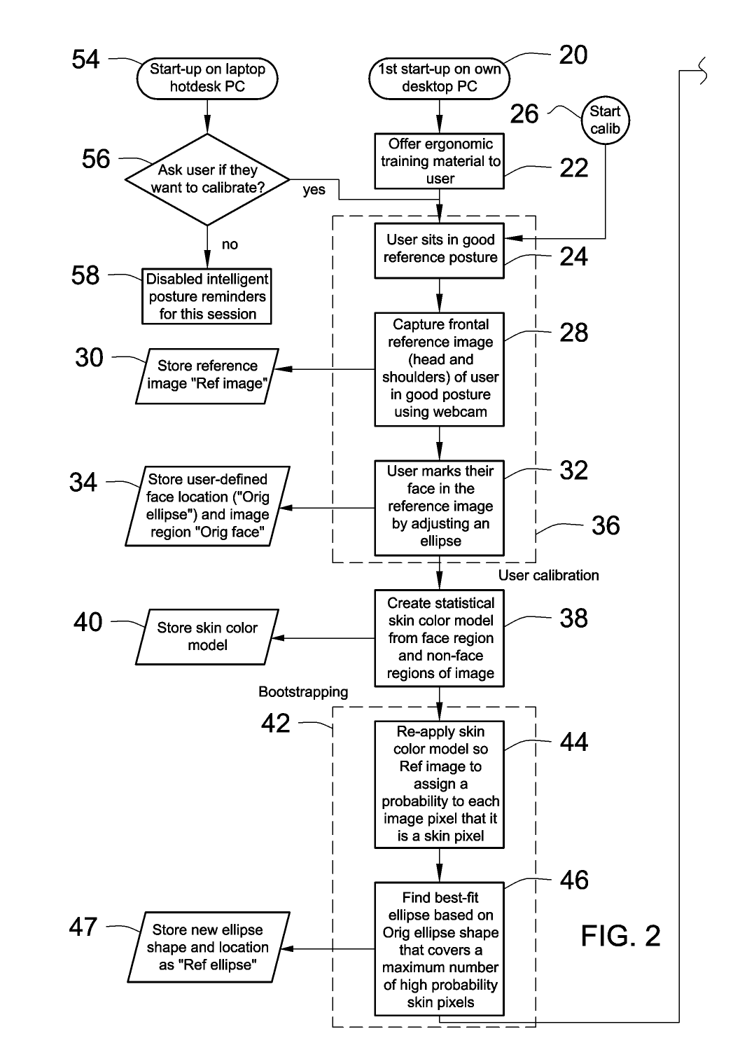

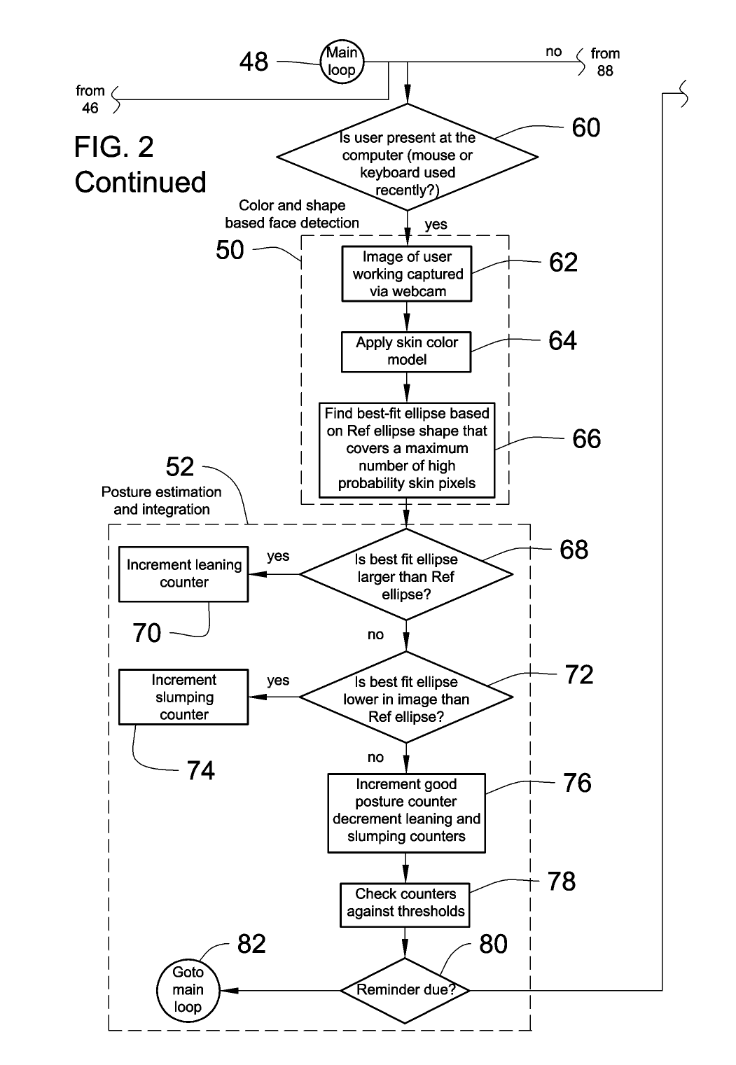

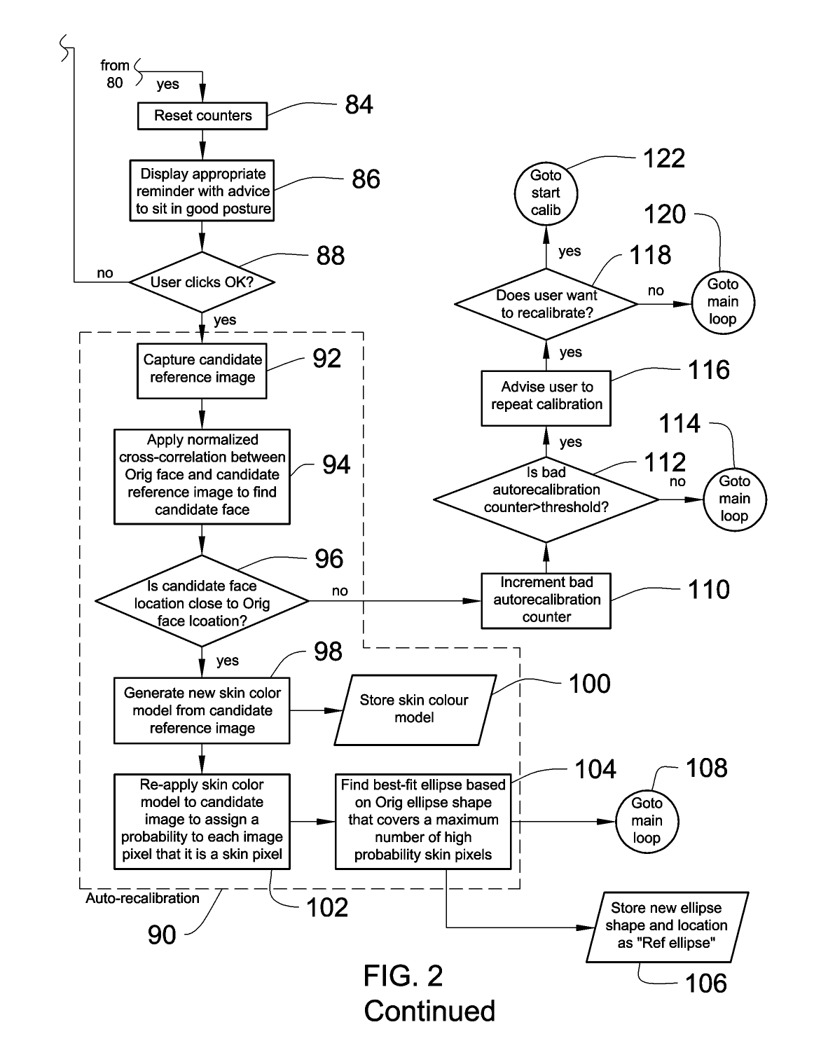

With the posture monitoring system according to the present invention newly installed on the computing device (8), the person (2) sitting at the computing device, hereafter referred to as a user, starts up their computing device [Box 20 of FIG. 2]. The system then plays ergonomic training material to the user on the computing device (8), which is displayed on the screen (16) and which shows the user how to sit in a good posture [Box 22 of FIG. 2]. This material can then be accessed by a user at any time thereafter. Based on this training material, the user sits in a good posture [Box 24 of FIG. 2] and a user calibration procedure is started by the system operating on the computing device (8) [Box 26 of FIG. 2].

The user calibration procedure proceeds to capture a frontal calibration reference calibration image of the head and shoulders of the user using the camera (14) connected to the computing device (8) [Box 28 of FIG. 2]. The captured image is then stored in a memory of the computing device (8) as ‘ref. image’ [Box 30 of FIG. 2]. The captured and stored ref. image is then displayed to the user on the screen (16) of the computing device and the system generates instructions on the screen instructing the user to position a face shaped template, for example an ellipse, on the screen centered on the part of the image showing the user's face. For example, the user might use a mouse device (11) connected to or integral with the computing device (8) to drag an ellipse displayed on the screen (16) to a position and to alter the ellipse to a size which the user believes is centrally located over the user's face in the image and then click a button on the mouse (11) or other pointing device or keyboard (10) to instruct the system that the current position of the ellipse is centered over the face in the image [Box 32 of FIG. 2]. Alternatively, the user drags a curser to the face area, inputs the curser position, for example by clicking a mouse device (11), and the system automatically estimates the face size and location. The centered position of the ellipse is then stored in the memory of the computing device (8) as ‘orig. ellipse’ and the region of the captured image within the ellipse is stored in the memory of the computing device as ‘orig. face’ [Box 34 of FIG. 2]. The user calibration procedure delineated by the dotted line box (36) of FIG. 2 then goes on to a bootstrapping procedure delineated by the dotted line box (42) of FIG. 2, after a skin color model is generated.

The system operating on the computing device then generates a statistical skin color model from the stored ‘orig. face’ region of the captured image with respect to the remainder of the image, i.e. a ‘non-face’ region of the image which is outside of the user centred ellipse [Box 38 of FIG. 2] and the generated skin colour model is then stored in the memory of the computing device [Box 40 of FIG. 2].

The skin color model is a statistical model which assigns a probability of a pixel being within the face region or outside of the face region of the image, based on pixel properties such as tint, hue and/or saturation values located within the user placed ellipse and outside of the user placed ellipse.

The skin color model assigns a probability to each tint, hue and/or saturation value combination for the likelihood of that value or combination of values being associated with a pixel of the image representing skin. Several copies are then made of the skin color model and a smoothing function is applied to each copy, each with different levels of smoothing and the smoothed copies of the skin color model are stored in the memory of the computing device (8). This smoothing step makes the skin color model more robust when varying lighting conditions occur for subsequently captured images of the user.

The system operating on the computing device (8) then carries out the bootstrapping procedure which is delineated by the dotted line box (42) of FIG. 2 and is used to generate a more stable face model by correcting the position of the ‘orig. ellipse’ as placed by the user to generate a ‘ref. ellipse’. The bootstrapping procedure is described below. Each stored skin color model (the copies to which different levels of smoothing have been applied) is applied to ref. image. For each pixel of the ref. image that pixel's color (in terms of its tint, hue and/or saturation values) is looked up on the color model and a probability is assigned to it of it being a skin pixel. For each stored skin color model the bootstrapping procedure generates a probability map of the ref. image, which should have high probability values where the face is and low values elsewhere [Box 44 of FIG. 2]. The bootstrapping procedure then makes multiple copies of the user defined ellipse, orig. ellipse, and resizes them to generate a series of different sized ellipses, with some smaller and some larger than orig. ellipse. Each of the series of ellipses are then run over a set of locations on each probability map of ref. image for each color model in turn and for each combination of stored color model, ellipse location and resized ellipse, the probabilities lying within the ellipse are summed to create a score for that particular combination of location, ellipse size and stored color model. A weighting factor is then applied to each score in order to compensate for the size of the ellipse and the combination of stored skin color model, ellipse size and ellipse location with the best score is selected [Box 46 of FIG. 2]. The ellipse size and ellipse location associated with the best score is then stored in the memory of the computing device (8) as ‘ref ellipse’ [Box 48 of FIG. 2]. This ‘ref. ellipse’ is then used to detect the position of a user's face until a user calibration or auto-recalibration procedure is carried out by the system. The color model associated with the best score is stored as current color model and is used to detect the position of a user's face until a user calibration or auto-recalibration is carried out by the system.

The bootstrapping procedure is carried out to remove user error, for example if the user places the ellipse well inside or well outside the true boundary to the face in the ref. image. The bootstrapping procedure uses the user defined orig. ellipse as a starting point for a search for the face in the ref. image. The orig. ellipse is never used directly in the detection of a user's posture, but only as a starting point for the bootstrapping procedure described above or the auto-recalibration process described below.

Where the computing device is a laptop or is used in a hot desking scheme, then each time, thereafter, that the user starts up their computing device [Box 54 of FIG. 2], the posture monitoring system operating on the computing device (8) will generate a message, which is displayed on the screen (16) of the computing device asking the user whether they want to use the system for that computer session [Box 56 of FIG. 2]. If they do not then the system is disabled until next time this user starts up the computing device (8) [Box 58 of FIG. 2]. If they do then the user calibration procedure (36) and the bootstrapping procedure (42) of FIG. 2 are carried out, as is described above. Otherwise, where the computing device is in a fixed configuration and used by only one user, the system carries out the autorecalibration procedure of the dashed box (90) of FIG. 2 instead, as described below.

Once the user calibration and the bootstrapping procedure or the autorecalibration process have been carried out, the system operating on the computing device (8) proceeds to the main loop [Box 48 of FIG. 2]. This main loop comprises Box 60 of FIG. 2, a color and shape based face detection procedure delineated by the dashed box (50) of FIG. 2 and a posture estimation and integration procedure delineated by the dashed box (52) of FIG. 2. The main loop periodically captures images of the user and repeats during the user's session at the computing device (8) until a posture reminder or message is due, as is described below.

At the start of the main loop the system operating on the computing device (8) determines whether the user is present at the computing device by detecting whether the user has recently used a keyboard (10) or a mouse device connected to or integral with the computing device [Box 60 of FIG. 2]. If the user is not present, the bad posture counters, described below, are decremented so that the user does not get a reminder as soon as they return to the computing device. If the user is present then the system operating on the computing device (8) carries out a color and shape based face detection procedure (50).

The face detection procedure (50) begins by capturing an image of the user using the camera (14) [Box 62 of FIG. 2] and storing it in the memory of the computing device (8) as ‘current image’. Then the stored current skin color model is applied to the stored ‘current image’. For each pixel of the current image that pixel's color (in terms of its tint and saturation values) is looked up on the current skin color model and a probability is assigned to it of it being a skin pixel so as to generate a probability map of the ref. image, which should have high probability values where the face is and low values elsewhere [Box 64 of FIG. 2]. The face detection procedure then makes multiple copies of the user defined ellipse, orig. ellipse, and resizes them to generate a series of different sized ellipses, with some smaller and some larger than orig. ellipse. Each of the series of ellipses are then run over a set of locations on the probability map of current image for the current skin color model and for each combination of ellipse location and resized ellipse, the probabilities lying within the ellipse are summed to create a score for that particular combination of location and ellipse size. A weighting factor is then applied to each score in order to compensate for the size of the ellipse and the combination of the ellipse size and the ellipse location with the best score is selected. The ellipse size and ellipse location are then stored as current best fit ellipse [Box 66 of FIG. 2].

The system operating on the computing device then carries out the posture estimation and integration procedure (52) of FIG. 2. This procedure first determines whether the current best fit ellipse is significantly larger than the ref. ellipse generated from the bootstrapping procedure (42) [Box 68 of FIG. 2]. If it is then this indicates that the user (2) has moved from a good posture and is leaning towards the screen (16) or is projecting their neck forwards and a leaning counter of the system stored in the memory of the computing device is incremented [Box 70 of FIG. 2] and the system goes to box 78 of FIG. 2. The greater the degree by which the current best fit ellipse is than the ref. ellipse, the more the leaning counter is incremented. Also, a good posture counter of the system stored in the memory of the computing device is set to zero. If it is not then the procedure determines whether the current best fit ellipse is significantly lower in the image than the ref. ellipse. If it is then this indicates that the user (2) has moved from a good posture and is slumping, a slumping counter of the system stored in the memory of the computing device (8) is incremented [Box 74 of FIG. 2] and the system goes to Box 78 of FIG. 2. The bigger the difference is in height between the current best fit ellipse and the ref. ellipse the more the slumping counter is incremented. Also, the good posture counter is set to zero. If neither leaning or slumping is detected then the procedure increments the good posture counter and decrements the leaning and slumping counters [Box 76 of FIG. 2] and the procedure goes on to Box 78 of FIG. 2. The procedure at Box 78 of FIG. 2 then checks the counters against a threshold for each counter. If the leaning counter exceeds a predetermined threshold then a leaning reminder is due [Box 80 of FIG. 2], the counters are all reset to zero [Box 84 of FIG. 2] and a leaning reminder is generated by the system, which may be an audio alarm and/or may be a message displayed to the user on the screen (16) [Box 86 of FIG. 2]. The leaning reminder message optionally provides advice to the user about how to move into a good posture from their current position in which they are leaning towards the screen (16). If the slumping counter exceeds a predetermined threshold then a slumping reminder is due [Box 80 of FIG. 2], the counters are all reset to zero [Box 84 of FIG. 2] and a slumping reminder is generated by the system and may be an audio alarm or a message displayed to the user on the screen (16) [Box 86 of FIG. 2]. The slumping reminder message optionally provides advice to the user about how to move into a good posture from their current position in which they are slumping. If a sum of the leaning counter and the slumping counter exceeds a predetermined threshold, higher than the other thresholds, then a reminder is due [Box 80 of FIG. 2], the counters are all reset to zero [Box 84 of FIG. 2] and either a leaning or slumping reminder is generated by the system, depending on the most recently incremented counter (slumping counter or leaning counter) and is displayed to the user on the screen (16) [Box 86 of FIG. 2]. This attempts to remedy the situation in which the user is alternating between two poor postures, which is not as bad as sitting for a long time in a single bad posture but which still requires a reminder to move to a good posture. If the good posture counter exceeds a predetermined threshold then a message is due [Box 80 of FIG. 2], the counters are all reset to zero [Box 84 of FIG. 2] and a good posture message is generated by the system and displayed to the user on the screen (16) [Box 86 of FIG. 2]. The good posture message congratulates the user, but also reminds them that either sitting rigidly is not good for the body or that this message may be an indication that the system needs to re-calibrate. The user then acknowledges the message by clicking OK, for example by using the mouse device or the keyboard (10) connected to the computing device (8) [Box 84 of FIG. 2].

In response to the user acknowledging the message the system operating on the computing device or after any message or reminder, at switch on of the computing device or when a user comes back from a break, the system may initiate an auto-recalibration procedure delineated by dashed box (90) of FIG. 2.

The auto-recalibration procedure of the system which operates on the computing device (8) uses an alternative face detection process than the user calibration procedure delineated by dashed box (36) of FIG. 1. The auto-recalibration procedure updates the current skin color model and the current best fit ellipse. The system generates a message asking a user to sit in a good posture, which message is displayed on the screen (16) of the computing device and/or is a verbal message with a countdown. Then a candidate autorecalibration reference image of the user in the good posture is captured by the camera (14) and stored in the memory of the computing device as ‘candidate ref. image’ [Box 92 of FIG. 2]. Then a face detection technique, for example, a normalized cross-correlation is carried out between the candidate ref. image and orig. face to locate the best match between the candidate ref. image and orig. face [Box 94 of FIG. 2]. The location for the best match for the face in the candidate ref. image is then compared to the location for the orig. face [Box 96 of FIG. 2] and if they are closer than a predetermined threshold a new skin color model is generated from the candidate reference image [Box 98 of FIG. 2]. The generation of this new skin color model uses a process similar for that for generating the skin color model after the user calibration and as described above for Box 38 of FIG. 2. The new skin color model is then stored in the memory of the computing device (8) [Box 100 of FIG. 2]. The new skin color model may replace the previous skin color model or may be used to update the previous skin color model in order to take into account lighting variations over time. The auto-recalibration procedure then re-applies the new skin color model to candidate ref. image to assign a probability to each pixel of candidate ref. image that it is a skin pixel [Box 102 of FIG. 2]. This is a similar process to that described above in relation to Box 44 of FIG. 2. Then based on the probability map generated at Box 102, a new best fit ellipse based on orig. ellipse that covers a maximum number of high probability skin pixels is determined [Box 104 of FIG. 2] using a process similar to that described above in relation to Box 46. The new best fit ellipse is then stored as ‘ref. ellipse’ in the memory of the computing device (8) replacing the previously stored ‘ref. ellipse’ [Box 106 of FIG. 2] and then the system returns to the main loop [Box 108 of FIG. 2] and returns to Box 48 of FIG. 2.

If the location for the best match for the face in the candidate ref. image and the location for orig. face are further away than a predetermined threshold [Box 96 of FIG. 2] a bad auto-recalibration counter stored in the memory of the computing device is incremented [Box 110 of FIG. 2]. The system then determines whether the bad auto-recalibration counter is greater than a predetermined threshold [Box 11 2 of FIG. 2]. If it is not then the system proceeds back to the main loop [Box 114 of FIG. 2], i.e. to box 48 of FIG. 2. If it is then the system generates a message indicating to the user that a repeat user calibration is advisable and asking the user whether they want to undertake a user calibration procedure and this message is displayed on the screen (16) [Box 116 and 11 8 of FIG. 2]. The user indicates whether they want to undertake a user calibration procedure by inputting yes or no using the mouse device or keyboard (10) connected to the computing device (8). If the user indicates no, then the system proceeds back to the main loop [Box 120 of FIG. 2], i.e. to box 48 of FIG. 2. If the user indicates yes, then the system proceeds to the user calibration process and bootstrapping procedure [Box 122 of FIG. 2], i.e. to Box 26 of FIG. 2.

Each time a user calibration procedure and bootstrapping procedure is carried out by the system, a new ref. image, skin color model and ref. ellipse are generated and stored in the memory of the computing device, replacing any previously stored values.

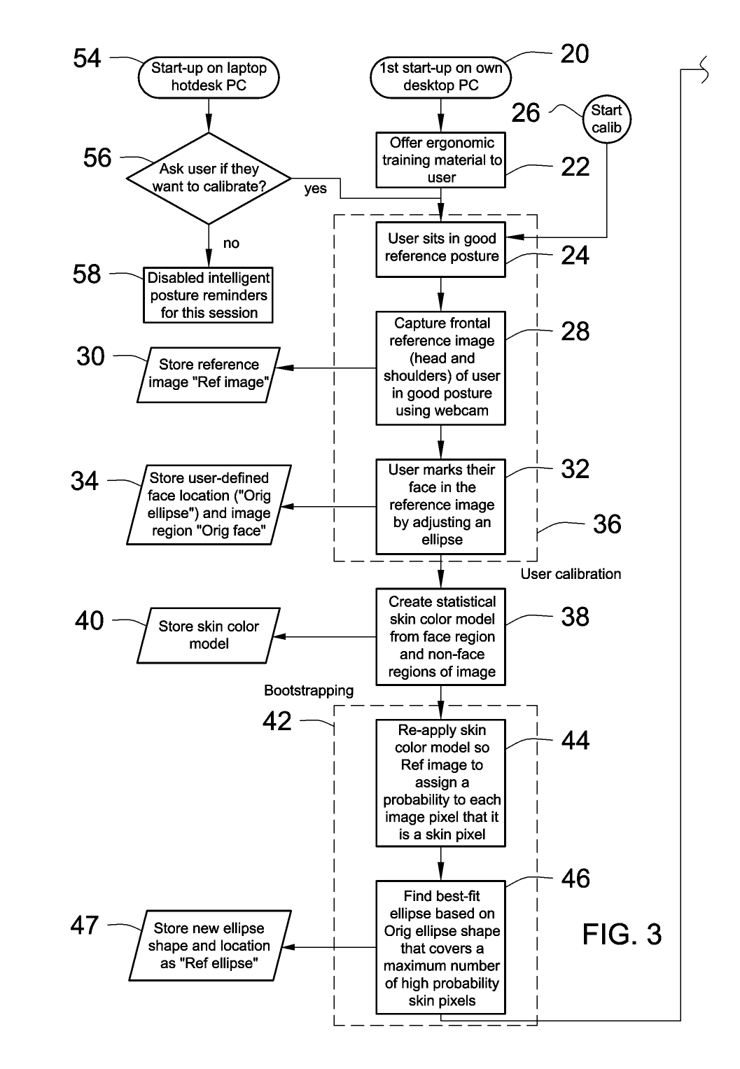

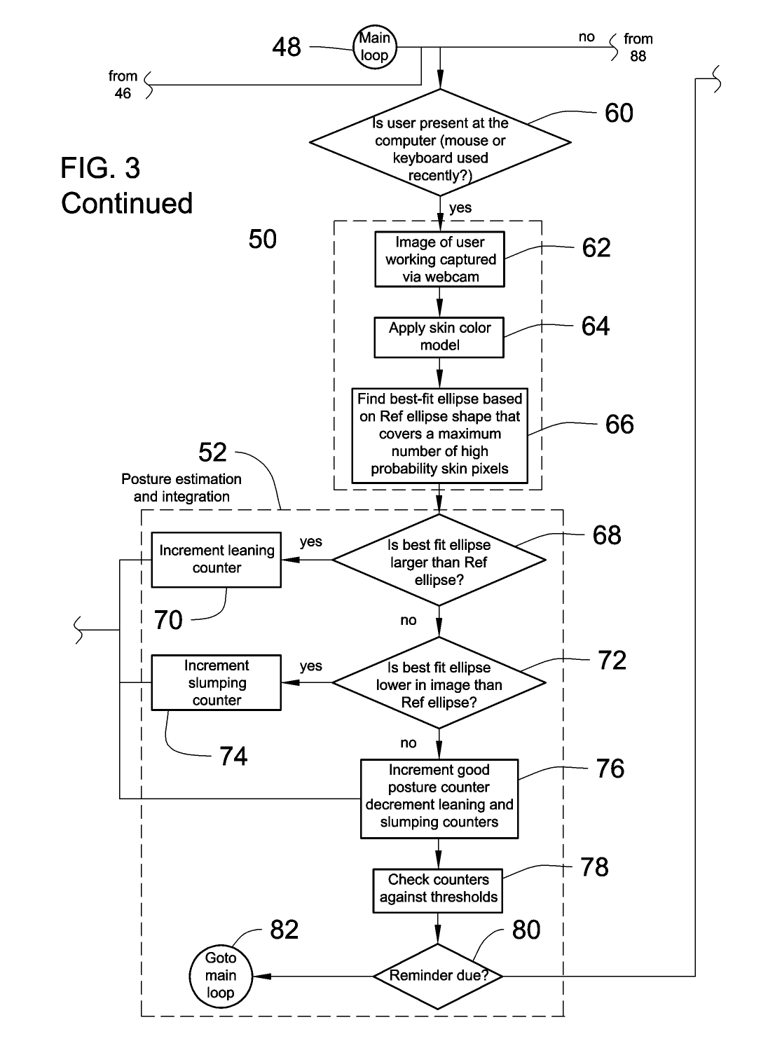

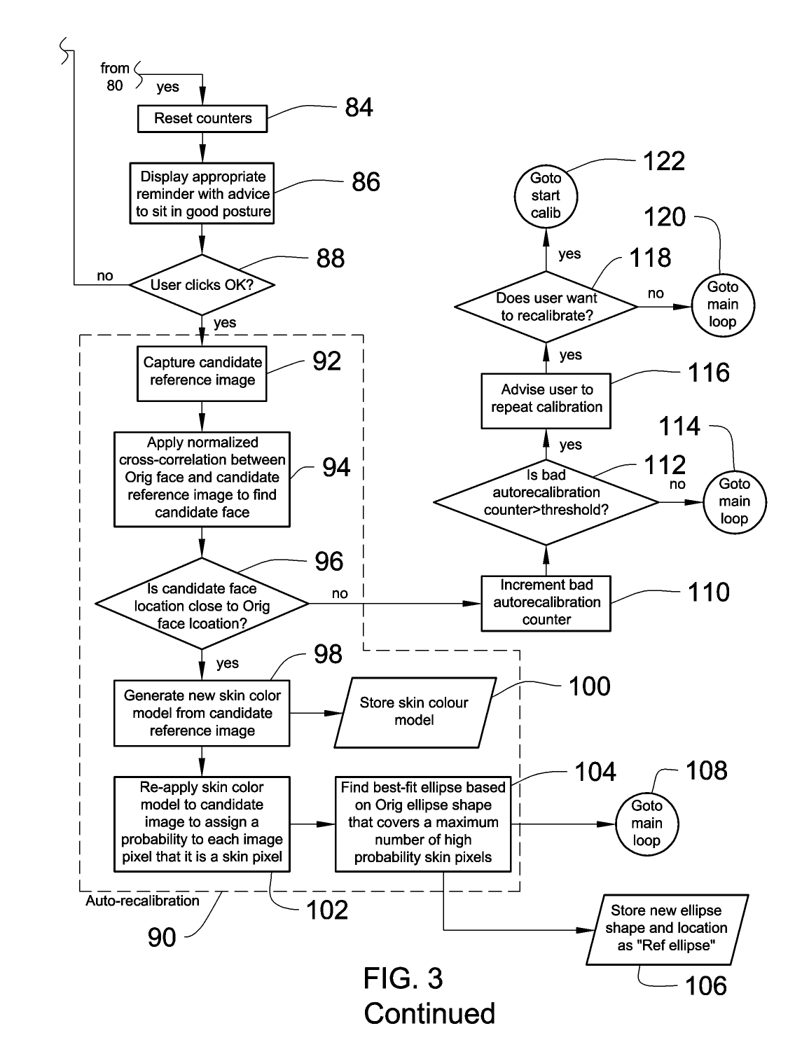

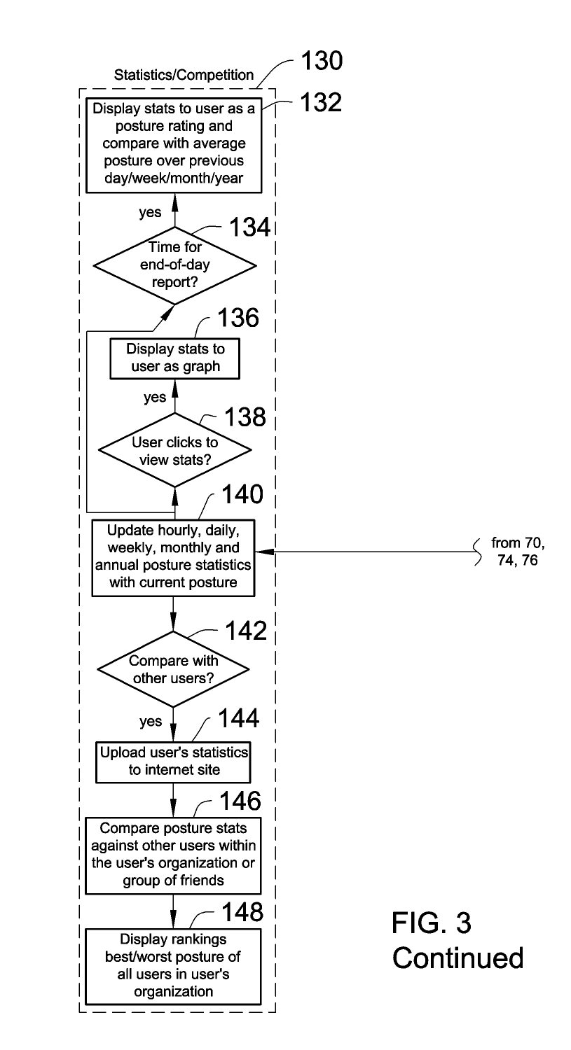

FIG. 3 shows a flow chart showing the steps of FIG. 2, with like parts identified by like numerals and with steps showing an additional posture rating system (130). Periodically, data from the incremented leaning, slumping and good posture counters [Boxes 70, 74 and 76 of FIG. 3] are used to update posture statistics with the current posture [Box 140 of FIG. 3]. The posture statistics may be generated as the percentage of leaning increments of the total number of increments made, the percentage of slumping increments of the total number of increments and the percentage of good posture increments of the total number of increments. When a user generates an input to the system to view their posture statistics [Box 138 of FIG. 3], the posture statistics are displayed on a screen of the system [Box 136 of FIG. 3], for example, the screen of the computing device on which they are working.

Alternatively or in addition, a time, such as a time just before the end of a typical working day, may be input into the system, for example by a user. When this time arrives [Box 134 of FIG. 3] the system prepares a posture rating [Box 132 of FIG. 3] derived from the updated posture statistics [Box 140 of FIG. 3]. The posture rating may for example be calculated as the number of good posture increments minus the number of poor (slumping and leaning) increments recorded that day. Alternatively, the posture rating may be calculated based on the percentage of good posture and the percentage of poor posture. This can then be compared with the average posture rating for that user over the previous day, week, month or year. The posture rating for that day and optionally one or more of the average posture ratings are than displayed on a screen of the system, for example, the screen of the computing device on which they are working [Box 132 of FIG. 3].

Where a group of users are using the system according to the present invention, for example workers for the same organization, the system can be set to compare the posture statistics [Box 140 of FIG. 3] with the other users or a user can opt to share their posture statistics with the other users [Box 142 of FIG. 3]. Where this is the case the users' statistics are periodically uploaded to an internet site or central server [Box 144 of FIG. 3]. The internet site or central server then compares the user's posture statistics with others using the system according to the present invention where their posture statistics has also been uploaded data to that internet site or central server [Box 146 of FIG. 3]. This comparison is then displayed to the users of the system with data uploaded to the internet site or central server [Box 148 of FIG. 3]. For example the comparison can be displayed on a screen of the system, for example, the screen of the computing device on which they are working. The comparison may generate a ranking of all participating users and/or display the identity of the best and/or worst ranking user. This can encourage competition between groups of friends or co-workers and so encourage them to work on their good posture.

While a preferred embodiment of the system and method for improving posture has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for monitoring the posture of a user of the system, said system comprising:
a camera device for periodically capturing an image of a user; and
wherein for each captured image:
means for applying a previously determined face detection model to the image to detect a face of a user in the image;
means for comparing the detected face to a previously determined good posture face to detect an instance of good posture;
means for generating a good posture message to a user after a number of instances of good posture are detected.

2. The system according to claim 1 further comprising means for comparing the detected face to a previously determined good posture face to detect an instance of poor posture; and means for generating a poor posture reminder to a user after a number of instances of poor posture are detected.

3. The system according to claim 1, wherein the means for comparing compares the position of the detected face within the image to the position of the previously captured good posture face to detect an instance of good posture.

4. The system according to claim 1, wherein the means for comparing compares the size of the detected face with the size of the previously captured good posture face to detect an instance of good posture.

5. The system according to claim 1, wherein the means for comparing compares the position of the detected face within the image to the position of the previously captured good posture image and compares the size of the detected face with the size of the previously captured good posture face to detect an incidence of good posture.

6. The system according to claim 2 further comprising means for delaying the good posture message on detecting an instance of poor posture.

7. The system according to claim 1 further comprising calibration means for periodically updating the previously determined good posture face and the previously determined face detection model.

8. The system according to claim 7, wherein the camera captures an autorecalibration reference image of a user prompted to move into a good posture and the system additionally comprises an autorecalibration means comprising:
means for comparing the user positioned face as determined by a user positioned face template to the autorecalibration reference image;
means for determining whether a face in the autorecalibration reference image corresponds to the user positioned face; and
after a predetermined number of instances of the face in the autorecalibration reference image not corresponding to the user positioned face, using the calibration means for determining an updated previously determined good posture face.

9. The system according to claim 8, wherein the camera captures an autorecalibration reference image of a good posture and the system additionally comprises an autorecalibration means comprising:
means for comparing the user positioned face as determined by a user positioned face template to the autorecalibration reference image;
means for determining whether a face in the autorecalibration reference image corresponds to the user positioned face; and
where the face in the autorecalibration reference image corresponds to the user positioned face, the system additionally comprises:
means for creating an updated face detection model based on the autorecalibration reference image;
means for applying the updated face detection model to the autorecalibration image and for assigning a reference template over an area of the image corresponding to the face and for using the template so as to determine an updated previously determined good posture face.

10. The system according to claim 2 further comprising means for calculating a good posture rating related to the number of incidences of good posture detected and the number of incidences of poor posture detected.

11. The system according to claim 10 further comprising comparison means for comparing good posture ratings from a plurality of users of the system.

12. A method for monitoring the posture of a user, said method comprising the steps of:
capturing an image of a user; and
for each captured image:
applying a previously determined face detection model to the image to detect a face of a user in the image;
comparing the detected face to a previously determined good posture face to detect an instance of good posture; and
generating a good posture message to a user after a number of instances of good posture are detected.

13. The method according to claim 12 further comprising the steps of: comparing the detected face to a previously determined good posture face to detect an instance of poor posture; and generating a poor posture reminder to a user after a number of instances of poor posture are detected.

14. The method according to claim 12, wherein the step of comparing comprises comparing the position of the detected face within the image to the position of the previously captured good posture face to detect an instance of good posture.

15. The method according claim 12, wherein the step of comparing comprises comparing the size of the detected face with the size of the previously captured good posture face to detect an instance of good posture.

16. The system according to claim 12, wherein the step of comparing comprises comparing the position of the detected face within the image to the position of the previously captured good posture image and comparing the size of the detected face with the size of the previously captured good posture face to detect an incidence of good posture.

17. The method according to claim 13 further comprising the step of delaying the good posture message on detecting an instance of poor posture.

18. The method according to any claim 12 further comprising a calibration step for periodically updating the previously determined good posture face and the previously determined face detection model.

19. The method according to claim 13 further comprising the step of calculating a good posture rating related to the number of incidences of good posture detected and the number of incidences of poor posture detected.

20. The method according to claim 19 further comprising the step of comparing good posture ratings from a plurality of users of the system.
